(19) United States
(12) Patent Application Publication
(10) Pub. No.: US 2005/0218135 A1
(43) Pub. Date: Oct. 6, 2005

(54) Climate control device for stationary climate control of a motor vehicle

(75) Inventors: Wolfgang Kraemer, Muenchen (DE); Noureddine Khelifa, Muenchen (DE); Oliver Horn, Muenchen (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 11/036,174

(22) Filed: Jan. 18, 2005

(30) Foreign Application Priority Data
Jan. 16, 2004 (DE) 10 2004 002 445.6

(51) Int. Cl. H01M 8/04; H01M 8/12; B60L 1/02; B60H 1/00

(52) U.S. Cl. 219/202; 429/26; 165/202

(57) ABSTRACT

A climate control device for stationary control of the climate in a motor vehicle has a heat pump circuit with a first heat exchanger for taking up ambient heat and a second heat exchanger for discharging heat into the vehicle interior and an electrically or mechanically drivable compressor which is located in the flow direction of the heat pump circuit between the first and the second heat exchanger, and a booster set for producing electrical or mechanical power, the electrical or mechanical power being used at least in part to drive the compressor. In addition, there is a third heat exchanger by which the exhaust heat of the booster set is transferred to the heat pump circuit. In this way, good efficiency is ensured for the climate control device in heating operation in stationary operation.

### BACKGROUND OF THE INVENTION

1. Field of the Invention

The invention relates to a climate control device for stationary climate control of a motor vehicle. The possibility of climate control of a motor vehicle when stationary, especially heating the vehicle, is becoming more and more important. In addition to camping L vehicles, it is especially important in trucking to be able to heat the cab over a longer time interval since the cab is also used by drivers as a sleeping area.

2. Description of Related Art

Therefore, heating of the vehicle interior often takes place by the exhaust heat of the vehicle engine being used to heat the interior. In addition, using fuel-fired auxiliary heaters is also known. They are integrated either into the cooling circuit of the engine and thus use the components of the climate control device which are ordinarily used when driving to implement the auxiliary heating function, or separate heating systems are built which are designed only for stationary operation.

These versions of stationary climate control have varied economic efficiency. In the least favorable case, the engine idles in order to implement auxiliary heating. Such an engine is completely oversized for operation as a heat supplier, and therefore, has poor efficiency. In addition, a large mass is heated at the same time; this also reduces efficiency. Fuel-fired auxiliary heaters have much better efficiency. In any case, the fuel-fired heaters produce emissions; this is undesirable in many cases.

### SUMMARY OF THE INVENTION

Therefore, a primary object of the present invention is to devise a climate control device for stationary climate control which has better efficiency.

This object is achieved by a climate control device for stationary climate control of a motor vehicle with a heat pump circuit with a first heat exchanger for taking up ambient heat and a second heat exchanger for discharging heat into the vehicle interior and an electrically or mechanically drivable compressor which is located in the flow direction of the heat pump circuit between the first and the second heat exchanger, and a booster set for producing electrical or mechanical power, the electrical or mechanical power being used at least in part to drive the compressor, and there being a third heat exchanger by which the exhaust heat of the booster set is transferred to the heat pump circuit.

An advantage of the invention is that, by implementing a climate control device with a heat pump circuit, the efficiency is further increased since ambient heat can be used in addition to heat the vehicle interior. In addition, the exhaust heat of the booster set is delivered to the heat pump circuit. The heat exchanger which is used for this purpose is preferably located between the first heat exchanger and the compressor. Basically, a heat pump circuit can also be operated without this additional heat delivery, but if CO₂ is used as the refrigerant, the temperature difference which has been produced by taking up ambient heat is not sufficient to operate the heat pump circuit efficiently. Here, the additional heat exchanger provides a remedy by the efficiency being increased by the additional delivery of heat. Of course, the climate control device of the invention can also be operated with R134a as the refrigerant.

In one advantageous development of the invention, the exhaust heat of the booster set is moreover used to further heat the air flow through the second heat exchanger. In addition, it is advantageous to use the electrical power produced by the booster set likewise for generating heat by an electrical heating element, a so-called PTF, being accommodated in the air flow through the second heat exchanger.

It is advantageous to use a fuel cell booster set as the booster set since it provides both exhaust heat and also electric power. The electric power can be used to drive the compressor, as indicated above for an electrical heating element, and also for further supply of the motor vehicle with electric power.

In one especially favorable configuration, the climate control device is set up such that certain components of the climate control device can be used both as described for heating operation and also for cooling operation, therefore a second operating mode. For example, a compressor is specified, the dual use of which for reasons of cost also constitutes a special advantage with respect to the total costs of the climate control device.

The invention is explained in further detail below with reference to the embodiments illustrated in the accompanying drawings.

### BRIEF DESCRIPTION OF THE DRAWINGS

FIG. 1 shows a first embodiment of a climate control device in accordance with the invention,

FIG. 2 shows the climate control device of FIG. 1 with two heat exchangers for front and rear operation,

FIG. 3 shows the climate control device of FIG. 1 modified by inclusion of an additional heat exchanger,

FIG. 4 shows a development of the climate control device of FIG. 3 with an additional electrical heating element,

FIG. 5 shows a modification of the embodiment of FIG. 4 with a combination of an additional internal combustion engine and generator as the booster set,

FIG. 6 is a representation of a CO₂ climate control device with a heating and cooling function in heating operation,

FIG. 7 shows a representation of the climate control device of FIG. 6 in cooling operation,

FIG. 8 is a representation of a modification of the climate control device of FIGS. 6 & 7 in heating operation, and

FIG. 9 shows a representation of the climate control device from FIG. 8 in cooling operation.

### DETAILED DESCRIPTION OF THE INVENTION

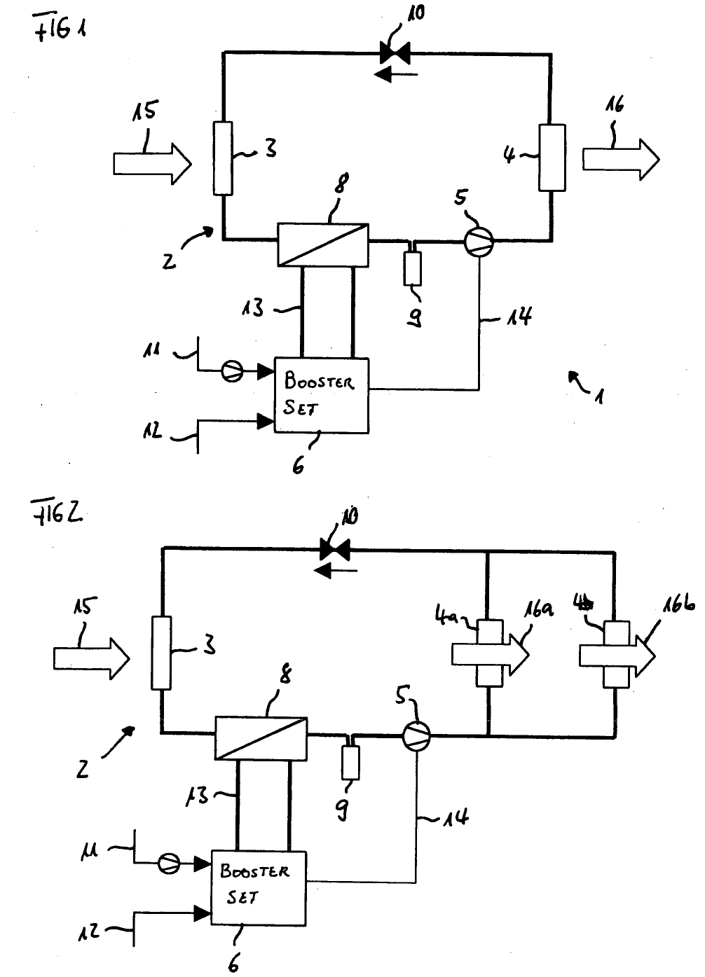

FIG. 1 shows a first embodiment of a climate control device in accordance with the invention having a heat pump circuit 2 with a first heat exchanger 3, a second heat exchanger 4, a third heat exchanger 8, a compressor 5, a collector 9 and an expansion valve 10. In the heat pump circuit 2, CO₂ is used as the refrigerant. Via the heat exchanger 3, heat is extracted from the air flow 15 from the environment and delivered to the heat pump circuit 2. The compressor 5 compresses the refrigerant and feeds it to the second heat exchanger 4. The air flow 16 through the heat exchanger 4 takes up heat from the heat pump circuit 2 and is routed preferably into the interior of the motor vehicle to heat it. Via the expansion valve 10, the refrigerant is then routed again to the first heat exchanger 3 so that the heat pump circuit is closed.

It is advantageous for the heat pump circuit to be able to extract more thermal energy from the environment for delivery to the vehicle interior than electrical or mechanical energy which need be used to drive the compressor 5.

In this heat pump circuit 2, it is a problem that, depending on the outside temperature, efficient operation of the heat pump circuit 2 is not possible. Via the heat exchanger 8, heat from the booster set 6 is additionally delivered to the heat pump circuit 2, by which the heat pump circuit 2 is shifted into an efficient operating range.

In the embodiment shown in FIG. 1, the booster set 6 is a fuel cell arrangement. It is connected to an air feed line 11 and a fuel feed line 12. The internal structure of the fuel cell booster set is of subordinate importance for this invention. Especially in operation in motor vehicles with an internal combustion engine, it is advantageous to use an SOFC (solid oxide fuel cell) as the fuel cell, upstream of which a reformer is connected which produces a hydrogen-containing gas from gasoline or diesel fuel in a catalytic reaction; this gas is, in turn, used as fuel gas for the SOFC.

The heat generated in the fuel cell booster set 6 is discharged via a cooling circuit 13 and is supplied to the third heat exchanger 8. In addition, the fuel cell booster set 6 delivers electric power which is supplied via a line 14 to the electrically operated compressor 5 to supply it with the required electric power.

An advantage of the climate control device of the invention with a heat pump circuit 2 is manifested mainly when the climate control device 1 is being used in stationary operation. When driving, generally enough thermal output is available so that an efficient climate control device is not necessary for heating purposes. However, in stationary operation, it is advantageous to use any possible source of thermal energy. The first heat exchanger 3 for taking up ambient heat, for this reason, makes an important contribution to enabling an efficient operating mode for the climate control device 1 in stationary operation. The combination of the first heat exchanger 3 with the third heat exchanger 8 makes it possible to operate the heat pump circuit 3 efficiently in spite of the small amounts of heat taken up from the environment.

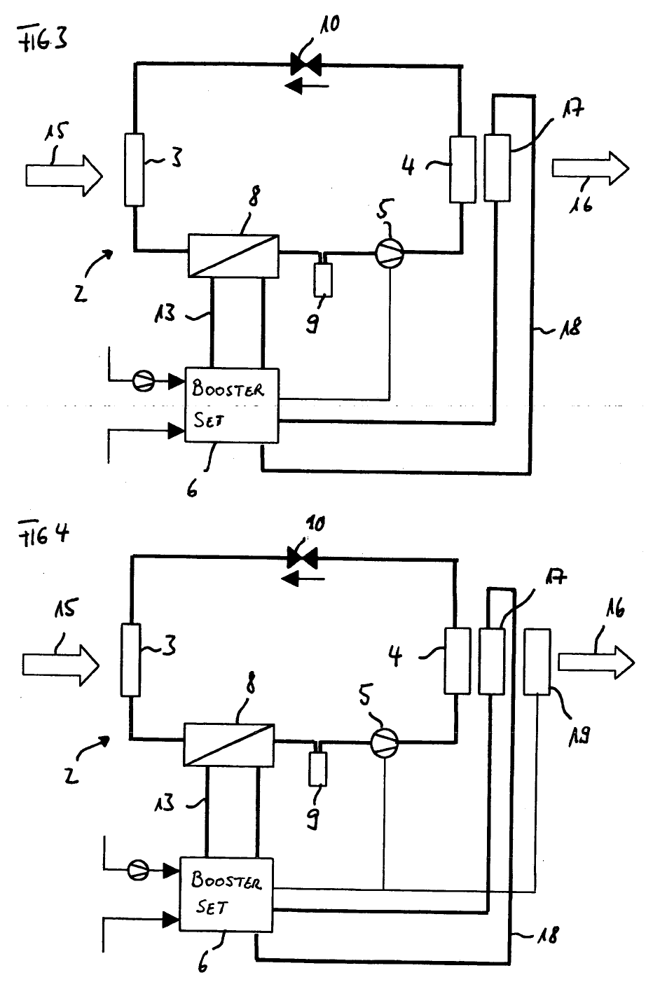

The climate control device as shown in FIG. 2 is made such that the front area and the rear area of the motor vehicle interior can be heated separately. Instead of the second heat exchanger 4 in FIG. 1, in FIG. 2 there are two heat exchangers 4a, 4b, and one air flow 16a can heat the front area by the heat exchanger 4a and one air flow 16b can heat the rear area of the motor vehicle by the heat exchanger 4b.

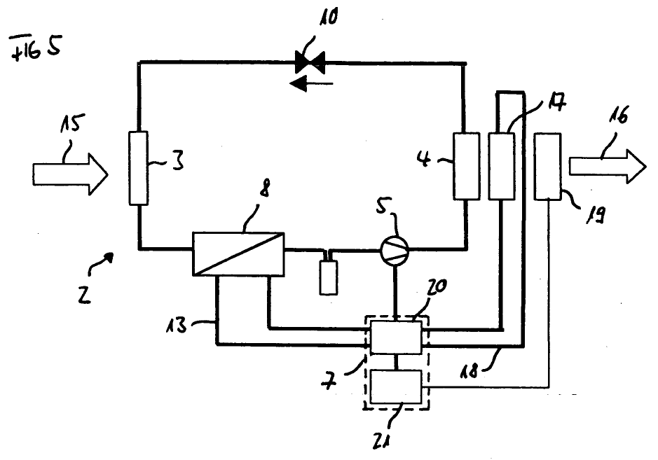

In the embodiment of a climate control device of the invention shown in FIG. 3, the exhaust heat of the fuel cell booster set 6 is used additionally for heating purposes by there being a cooling circuit 18 which cools the fuel cell booster set 6 and routes the heat to an additional heat exchanger 17 which is likewise located in the air flow 16 through the second heat exchanger 4. The air which has been preheated by the second heat exchanger 4 is thus further heated by the additional heat exchanger 17. The circuit 18 can, of course, be coupled to the circuit 13 which connects the fuel cell booster set 6 to the third heat exchanger 8, for example, by the third heat exchanger 8 and the additional heat exchanger 17 being connected in series. However, it is more advantageous to connect the heat exchangers 8, 17 in parallel and to provide an adjustment possibility in order to distribute the exhaust heat of the fuel cell booster set 6 as favorably as possible among the two heat exchangers 8 and 17 in any operating situation.

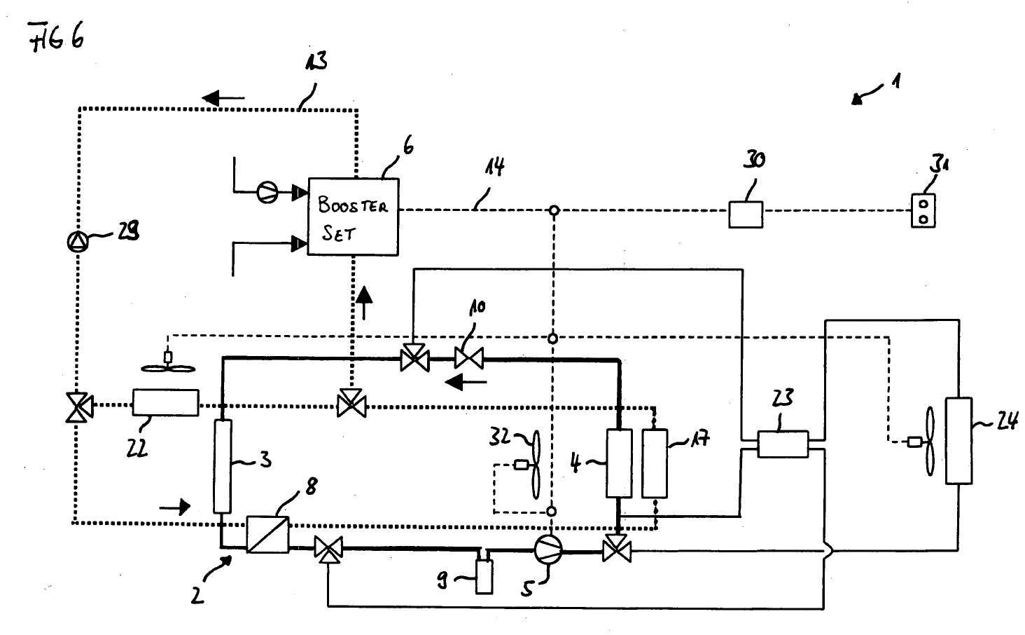

In the configuration of a climate control device as shown in FIG. 4, the electrical power produced by the fuel cell booster set is additionally used to heat the air flow 16. To do this, there is an electrical heating element, a so-called PTC element 19, which is supplied by the fuel cell booster set 6.

The thermal and electrical output produced by the fuel cell booster set 6 is thus used four times. The thermal output is routed to the heat exchangers 8, 17, while the electrical output is supplied to the compressor 5 and the PTC element 19. By the ingenious configuration of the climate control device which is dependent on the operating situation, these power consumers can be operated such that the power produced by the fuel cell booster set 6 is used completely and optimally to heat the motor vehicle interior. A control device which is necessary to control the climate control device is not shown in the figures, but is of course present.

In the climate control device from FIG. 5, instead of the fuel cell arrangement, an engine-generator unit 7 is used is used as the booster set. The engine-generator unit 7 comprises an internal combustion engine 20 and a generator 21. The internal combustion engine 20 is dimensioned such that it can be used to operate the climate control device, and if necessary, to supply other electrical consumers. Thus, the internal combustion engine 20 is matched to stationary operation of the motor vehicle climate control device.

The internal combustion engine 20 drives the compressor 5 and the generator 21. The exhaust heat produced by the internal combustion engine 20, as in the fuel cell arrangement, on the one hand, is routed to the third heat exchanger 8, and on the other, is routed to the additional heat exchanger 17. The electric power produced by the generator 21 is supplied, in turn, to the PTC 19. As an alternative to the mechanical driving of the compressor 5 by the internal combustion engine 20, it can also be electrically driven, and it would be supplied by the generator 21.

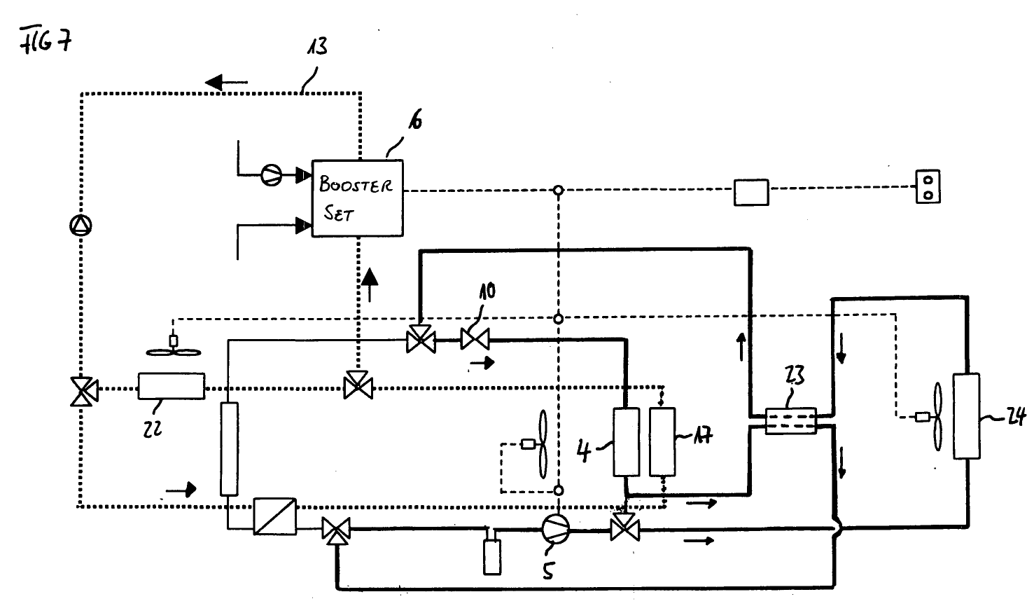

FIG. 6 shows a climate control device according to the invention which is set up both for heating and cooling. Several components of the climate control device are used in both operating modes. In FIG. 6, the operating mode for heating is active. The line segments used in this operating mode are shown bolded to improve clarity, while the unused line segments are shown thin. In the illustrated operating mode, the arrangement of the climate control device corresponds essentially to the arrangement from FIG. 3. The heat pump circuit 2 comprises the same components as the arrangement from FIG. 3, there are simply several valves which are necessary for switching between the two operating modes. The cooling circuit of the fuel cell booster set 6 is shown by the broken line. The exhaust heat of the fuel cell booster set 6, as in FIG. 3, is routed via the third heat exchanger 8 and the additional heat exchanger 17. Parallel to the lines via the third heat exchanger 8 and the additional heat exchanger 17, the cooling circuit can be closed via another heat exchanger 22. The heat exchanger 22 is designed to discharge heat from the cooling circuit of the fuel cell booster set 6 if not all of the available heat is to be used for heating purposes or if the climate control device is in cooling operation. In this case, the heat is discharged to the environment. The proportion of cooling liquid which is to flow via the heat exchanger 22, on the one hand, and the heat exchangers 8, 17, on the other, can be variably set. The cooling circuit 13 is maintained by a pump 29.

Furthermore, in the illustrated electrical system of the climate control device electric power produced by the fuel cell booster set 6 is used to drive the compressor 5, as in the preceding embodiments. Moreover, several fans are driven to produce a respective air flow through the heat exchangers. In addition, electric power is provided to other consumers of the motor vehicle. By means of a DC/AC converter 30, even an AC voltage with 110 V or 230 V can be generated and made available at an outlet 31 and to which household consumers can be connected.

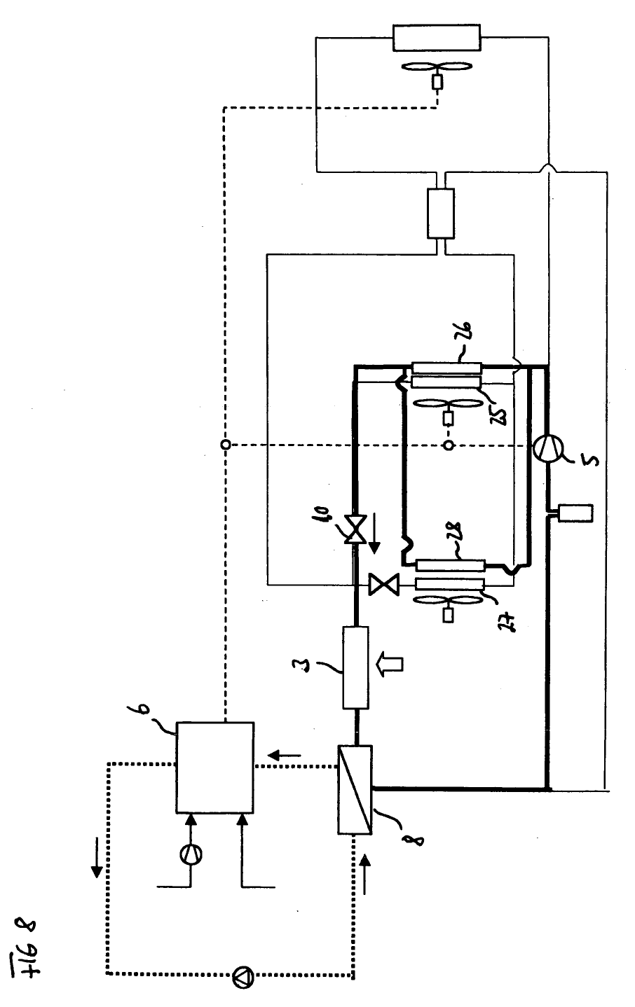

FIG. 7 shows the climate control device of FIG. 6 in cooling operation. In this operating mode, the line segments used are shown bolded, while the unused line segments are shown thin. The heat exchanger 4 works as an evaporator and takes up heat from the vehicle interior. This heat is routed to the internal heat exchanger 23 and the cooling circuit is again closed to the evaporator 4. The expansion valve 10 in this operating mode is operated in the opposite direction compared to the operating mode from FIG. 6. The heat exchanger 23 is, on the other hand, taken into the second cooling circuit which contains a condenser 24 and the compressor 5 which is used in heating operation. For reasons of cost, it is decisive that the compressor 5 can be used both in heating and cooling operation since it is an expensive component which has a significant share in the overall costs of the climate control device.

The fuel cell booster set 6 is also required in cooling operation to produce electrical energy. It is used in this embodiment also to drive the compressor 5. In order to discharge the exhaust heat of the fuel cell booster set 6, the cooling circuit 13 is in operation and discharges heat to the environment via the heat exchanger 22. The branch of the cooling circuit 13 which leads via the heat exchanger 17 is not active.

The heat exchanger 23 is necessary when the cooling circuit is to be operated with CO₂ as the refrigerant. The heat exchanger 23 is necessary to achieve a high output number (COP). The CO₂ refrigerant which emerges from the condenser 24 is cooled on the way to the expansion valve 10 by means of the heat exchanger 23. The heat is taken up by the refrigerant which emerges from the evaporator 4 and which has a temperature which is a few degrees lower than the refrigerant emerging from the condenser 24.

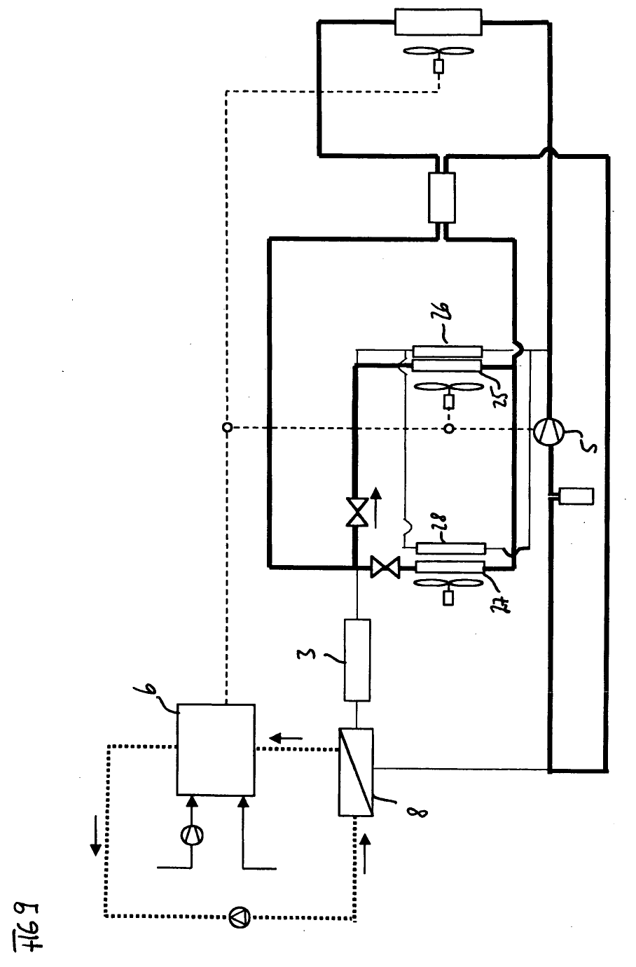

FIG. 8 shows a climate control device in accordance with the invention which, like the climate control device of FIG. 2, is equipped with heat exchangers 27, 28 for the front area and heat exchangers 25, 26 for the rear area. In contrast to the embodiments from FIGS. 2, 6 & 7, there are separate heat exchangers for heating and cooling operation. The heat exchangers 28, 26 are used in heating operation, while the heat exchangers 27, 25 are used in cooling operation. The advantage of this division is that, when changing from heating to cooling operation, a comparatively large amount of moisture is stored in the heat exchanger which can fog the windshields in a motor vehicle immediately after changing the operating mode. This is prevented by separating the heat exchangers.

The distribution of the heating and cooling output between the front area and the rear area can, of course, be adjusted via valves provided for this purpose (not shown).

FIG. 9 shows the climate control device from FIG. 8 in cooling operating. This shows that the heat exchangers 27, 25 are actively in operation in cooling operation.

Providing separate heat exchangers for heating and cooling operation does result in a cost increase, but it is relatively small. What is important with respect to the costs of a climate control device is that the compressor 5 can be used in both operating modes.

Other configurations of a climate control according to the invention are at the discretion of one skilled in the art and are therefore encompassed by the invention.

1. Climate control device for stationary climate control of a motor vehicle, comprising:
a heat pump circuit with a first heat exchanger for taking up ambient heat and a second heat exchanger for discharging heat into the vehicle interior, and compressor which is located between the first heat exchanger and the second heat exchanger in a flow direction of the heat pump circuit,
a booster set for producing power, the power provided at least in part to the compressor for driving it, and
a third heat exchanger by which exhaust heat of the booster set is transferred to the heat pump circuit.

2. Climate control device as claimed in claim 1, wherein the third heat exchanger is located between the first heat exchanger and the compressor in the flow direction of the heat pump circuit.

3. Climate control device as claimed in claim 1, wherein the heat pump circuit is filled with a CO₂ refrigerant.

4. Climate control device as claimed in claim 1, wherein an additional heat exchanger is provided in an air flow path through the second heat exchanger and to which heat from the booster set is supplied for further heating of the air flow.

5. Climate control device as claimed in claim 1, wherein an electrical heating element is provided in the air flow through the second heat exchanger.

6. Climate control device as claimed in claim 1, wherein, in a second operating mode, individual components of the heat pump circuit are operated to cool the vehicle interior.

7. Climate control device as claimed in claim 6, wherein the compressor is a component which is operable in the second operating mode.

8. Climate control device as claimed in claim 1, wherein the booster set is a fuel cell booster set.

9. Climate control device as claimed in claim 1, wherein the booster set is an internal combustion engine-generator unit which enables the climate control device to be operated independent of a vehicle engine.
